(19) United States
(12) Patent Application Publication
(10) Pub. No.: US 2020/0149322 A1
(43) Pub. Date: May 14, 2020

(54) LOCKING DEVICE

(71) Applicant: Clay Holland Heath, Lake Charles, LA (US)

(72) Inventor: Clay Holland Heath, Lake Charles, LA (US)

(21) Appl. No.: 16/189,821

(22) Filed: Nov. 13, 2018

(51) Int. Cl. E05B 73/00

(52) U.S. Cl. CPC E05B 73/0005; E05B 65/52

(57) ABSTRACT

A locking device for securing and handling objects is disclosed. The locking device includes a cable having a first end and a second end, wherein the cable includes a flexible metal wire extending throughout a length thereof and an outer protective cover enclosing the flexible metal wire therein. The locking device also includes a male connector arranged at the first end of the cable. The locking device further includes a locking member arranged at the second end of the cable, wherein the locking member includes a female connector with a radial through hole so as to mateably receive at least a portion of the male connector therein to engage therewith, and wherein the locking member is configured to lock the male connector in the female connector when engaged therewith so as to form a closed loop of the cable.

### FIELD OF THE PRESENT DISCLOSURE

The present disclosure relates generally to a locking device; and, in particular, to a multi-purpose locking device having a cable with locking member arranged inline therewith to be implemented for locking an object to a fixture, and/or to be used as a handle for an object.

### BACKGROUND

There are many locking devices known in the art which are implemented for anti-theft purposes. Such conventional devices, for instance implemented for locking portable equipment, generally, includes a padlock for locking one end portion of a security cable, which is connected to the portable equipment, to a fixture. For unlocking such locking device, a physical key is needed which should be always be available handy for unlocking purpose. On losing the key, it will be impossible to unlock the lock.

Some locking devices utilizes cables and chains which have been popular for locking a portable object to a fixture, such as a post or the like. However, cables and chains have inherent problems. Basically, the cables employed are plastic ropes of certain thickness, and chains employed have weak links. Therefore, many cables and chains can be cut open which defeats their purpose of securing the object. Having thicker and larger cables may be less prone to being cut, but their added size and weight can make them undesirable since users do not want to add and carry unnecessary weight for locking a portable object.

Alternatively, lightweight cable locks having a rigid plastic body are known in the prior art, and are typically used by travelers to secure luggage. However, such locks typically have a very small length of cable, which makes then usable for securing a portable object to an external fixture at a distance or the like. Furthermore, the plastic bodies of these locks are not usually impact or tamper resistant, which diminishes their security.

It is an object of the present invention to provide a simple and convenient locking device for locking the portable objects and equipment, which is superior to conventional locking devices known in the prior art.

### SUMMARY

The present disclosure describes a locking device. The locking device includes a cable having a first end and a second end, wherein the cable includes a flexible metal wire extending throughout a length thereof and an outer protective cover enclosing the flexible metal wire therein. The locking device also includes a male connector arranged at the first end of the cable. The locking device further includes a locking member arranged at the second end of the cable, wherein the locking member includes a female connector with a radial through hole so as to mateably receive at least a portion of the male connector therein to engage therewith, and wherein the locking member is configured to lock the male connector in the female connector when engaged therewith so as to form a closed loop of the cable.

In one or more embodiments, the locking member is a combination lock.

In one or more embodiments, the locking member includes a housing; and a plurality of dials rotatably mounted in the housing, wherein the male connector is locked in the female connector by operating one or more of the plurality of dials to a locking combination.

In one or more embodiments, the locking device includes a supporting strap arranged along the length of the cable therein.

In one or more embodiments, whereby upon direction of the cable such that the male connector passes through a fastener of an object and encircle a fixture, the male connector is locked in the female connector for locking the object to the fixture.

In one or more embodiments, the length of the cable ranges from 50 centimeters to 500 centimeters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates a diagrammatic view of a locking device, in accordance with one or more embodiments of the present disclosure;

FIG. 2 illustrates a partial cross-sectional diagrammatic view of a cable of the locking device of FIG. 1, in accordance with one or more embodiments of the present disclosure;

FIG. 3 illustrates an exemplary implementation in which the locking device of FIG. 1 is being used to secure an object against a fixture, in accordance with one or more embodiments of the present disclosure;

FIG. 4 illustrates an exemplary implementation in which the locking device of FIG. 1 is being used as a handle for an object, in accordance with one or more embodiments of the present disclosure;

FIG. 5 illustrates an exemplary implementation in which the locking device of FIG. 1 is being used for locking an object, in accordance with one or more embodiments of the present disclosure; and

FIG. 6 illustrates an exemplary implementation in which a locking device is being fixed to an object and used for securing the object to a fixture, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient, but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

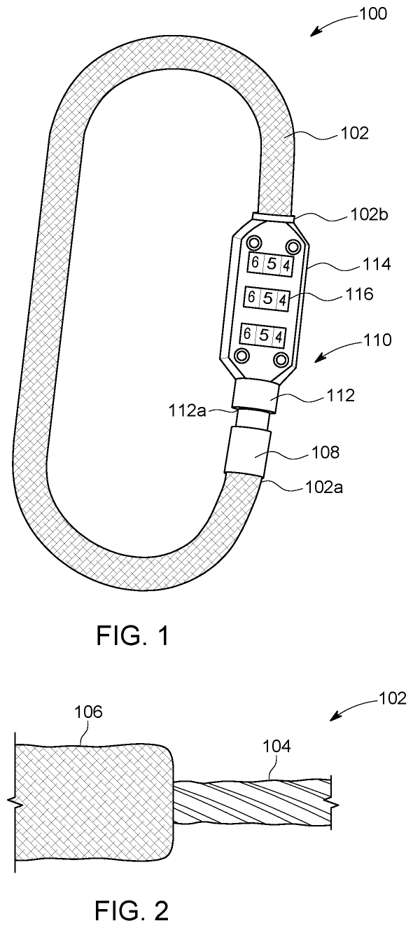

Referring to the drawings, FIG. 1 illustrates a locking device (generally designated by the numeral 100), in accordance with one or more embodiments of the present disclosure. The locking device 100 can be implemented for locking of an object to a fixture, as a handle for an object or for locking the object itself (as discussed in the subsequent paragraphs). The locking device 100 includes a cable 102. The cable 102 is in the form of an elongated flexible member. The cable 102 may be provided in various standard lengths. In one or more embodiments, the length of the cable 102 ranges from 50 centimeters to 500 centimeters. It may be appreciated that the locking device 100 may be customized to provide the cable 102 with a desired length for a particular application. For instance, if the locking device 100 is being implemented as a handle for an object, the length of the cable 102 may be customized based on an arrangement of the fasteners in the said object. Likewise, if the locking device 100 is being implemented for locking, say, a lid of an object, the length of the cable 102 may be customized based on the size and shape of the said object, as discussed below.

Referring to FIG. 2, illustrated is a partial cross-sectional diagrammatic view of the cable 102 showing its internal components, according to an embodiment of the present disclosure. As illustrated, the cable 102 includes a flexible metal wire 104 extending throughout the length thereof. Further, the cable 102 includes an outer protective cover 106 enclosing the flexible metal wire 104 therein. The flexible metal wire 104 can have elongated metal strands which may be arranged parallel or intertwined with each other. Herein, the flexible metal wire 104 may utilize any type of flexible but hard material. In one or more examples, the flexible metal wire 104 may be made of strands of steel. In other examples, the flexible metal wire 104 may be made of a solid length of steel of certain thickness. In yet other examples, the flexible metal wire 104 may be made of some other flexible but hard metals, alloys, or other materials including, but not limited to, high carbon spring steel, titanium, Nitinol, graphene, and the like.

Further, the outer protective cover 106 of the cable 102 can be made of virtually any flexible and/or bendable material such as solid plastic comprising nylon or polypropylene, which can be dyed or otherwise colored, or metal such as stainless steel, nickel plated mild steel, copper, or aluminum (typically with an anodized coating). In a multi-filament configuration, the protective cover 106 can be made of plastics, or metal such as stainless steel, chrome or nickel plated mild steel, brass, copper, or aluminum (typically with an anodized coating). In such multi-filament configuration, the filaments are typically twisted or braided together. In some examples, the protective cover 106 may further be covered by a plastic tube cover, such as made of vinyl or nylon, or plastic dip covered such as with vinyl or nylon.

As illustrated in FIG. 1, the cable 102 has a first end 102a and a second end 102b. The locking device 100 includes a male connector 108 arranged at the first end 102a of the cable 102. Further, as illustrated, the locking device 100 includes a locking member 110 arranged at the second end 102b of the cable 102. In the present embodiment, the locking member 110 includes a female connector 112. Generally, the male connector 108 and the female connector 112 have circular or cylindrical configurations, with the male connector 108 being in the form of a solid or hollow plug, and the female connector 112 having a radial through hole 112a so as to mateably receive at least a portion of the male connector 108 therein to engage therewith.

In one or more examples, the male connector 108 and the female connector 112 and component parts thereof can be made of plastic, such as by an injection molding process, including but not limited to nylon and polypropylene, or made of metal such as stainless steel, chrome or nickel plated mild steel, brass, copper, aluminum (typically with an anodized coating). Manufacturing processes such as adhesive fastening and thermal fusion can also be employed for plastic parts. The size of the connectors 108 and 112 can be up to one-half inch or larger in diameter. The outer surface of the connectors 108 and 112 can be textured and/or have recessed finger-gripping areas to aid in connecting and disconnecting thereof. Further, the outer surface of the connectors 108 and 112 can also include logos, or other matter printed thereon such as by silk screening or hot stamping processes. The connectors 108 and 112 can have configurations other than generally circular or cylindrical in cross-section, such as square, rectangular, oval, and polygonal without any limitations. The respective parts of male and female connector 108 and 112 can be chamfered or tapered as needed to facilitate smooth operation thereof. For example, the radial through hole 112a of the female connector 112 can be chamfered and/or tapered so as to aid in compressing the male connector 108 during insertion thereof.

In the locking device 100 of the present disclosure, the locking member 110 is configured to lock the male connector 108 in the female connector 112 when the male connector 108 is engaged with the female connector 112, so as to form a closed loop of the cable 102 (as illustrated in FIG. 1). In or more embodiments of the present disclosure, the locking member 110 is a combination lock. In such case, the locking member 110 includes a housing 114. The housing 114 may be generally cylindrical body with a window formed along a longitudinal direction therein. Although, the housing 114 of the locking member 110 is shown and described to be of cylindrical shape, it may be contemplated that the housing 114 may have any other suitable polygonal shape without any limitations. The locking member 110 further includes a plurality of dials 116 with inscribed symbols rotatably mounted in the housing 114. It may be seen that the dials 116 are arranged to be accessible via the window in the housing 114.

Using the locking member 110, the male connector 108 can be locked in the female connector 112 by operating one or more of the plurality of dials 116 to a locking combination, and vice-versa. Herein, the locking combination may be entered using the rotating dials 116 which interacts with several discs or cams (not shown), by using a set of rotating dials which directly interact with the locking mechanism, or through an electronic or mechanical keypad. Typically, the dials 116 are attached to a spindle (not shown) in the locking member 110. Inside the locking member 110, the spindle runs through several wheels and a drive cam (not shown). The number of dials 116 is determined by how many numbers are in the combination, i.e. one wheel for each number. When a user turns one or more dials 116, the spindle turns the drive cam, a drive pin (not shown) eventually makes contact with a small tab on the adjacent wheel of the plurality of wheels. Each wheel on the spindle has a notch (not shown) cut into it. When the right locking combination is dialed, all the wheels and their notches line up perfectly to dispose the locking member 110 in an open configuration. Further, the locking member 110 can be locked again by turning the dials 116 to a combination other than the preset locking combination. Such configuration for a combination lock using wheels and dials is known in the art and thus has not been described in detail herein for the brevity of the disclosure.

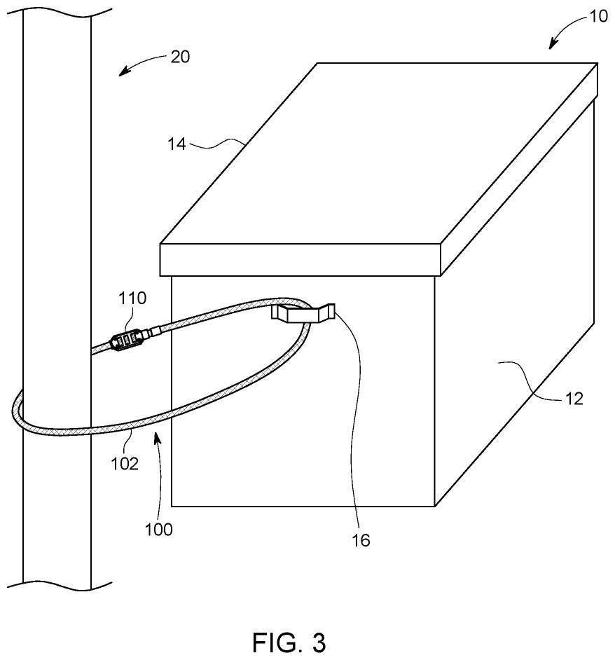

FIGS. 3-6 illustrate use-case scenarios of the locking device 100 of the present disclosure. As discussed above, the locking device 100 can be used for securing an object, such as an object 10; for instance, in one case, to a fixture, such as a fixture 20. The object 10 to be secured may refer to any personal equipment or item to be locked. The fixture 20 may be any fixed structure, or heavy installation difficultly movable or deadly fixed on a ground or floor surface. In present examples, the object 10 is an ice-chest, also known as ice-box. Herein, the object 10 includes a box 12 with a lid 14 removably arranged thereon, and one or more fasteners 16 fixedly attached thereto which also acts as handles for the object 10 in this case. In use-case, for instance, if a person is at a relatively open area such as a beach and the person has an ice-chest for keeping beverages chilled for drinking, the person cannot leave their spot at the beach without taking the ice-chest with them for fear it will be stolen. The person must therefore carry the ice-chest with them to get food, go to the restroom or to perform other activities. For instance, if the person wants to go in the water to swim, the person must have another person such as a spouse watch their ice-chest while they are in the water. Otherwise, the person must place the ice-chest as close to the water as possible to keep an eye on the ice-chest. The additional burdens of watching the ice-chest and carrying it makes participation in activities or carrying items such as food trays more difficult. Therefore, to ensure that the object 10 is not being stolen, the persons must keep the object 10 with them at all times. In some situations, carrying the object 10 at all times becomes burdensome and makes some activities almost impossible.

As illustrated in FIG. 3, the locking device 100 of the present disclosure can be implemented for securing the object 10 to the fixture 20. Herein, the cable 102 of the locking device 100 is directed such that the male connector 108 passes through the fastener 16 of the object 10 and encircle the fixture 20, and thereafter the male connector 108 is locked in the female connector 112 for locking the object 10 to the fixture 20. The process for locking the male connector 108 with the female connector 112 is same as described in the preceding paragraphs. Therefore, the present locking device 100 achieves the need to stow the object 10 in a secure manner, and thereby alleviate the need to carry the object 10 during an activity. It may be appreciated that the cable 102 of the locking device 100 can be continuously and simultaneously extended to pass through a plurality of fasteners, similar to the fasteners 16, respectively fixed on multiple equipment including other belongings like bags, and the related peripheral equipment of the user to lock the multiple equipment together to the fixture 20.

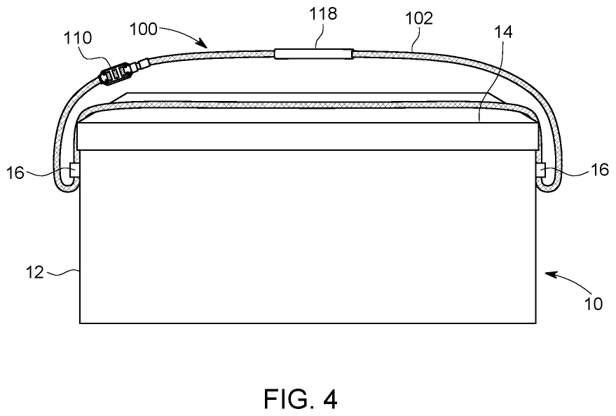

FIG. 4 illustrates an implementation of the locking device 100 being used as a handle for the object 10. Herein, the cable 102 passes through two of the opposing fasteners 16 arranged on the box 12, and thereafter the male connector 108 is locked in the female connector 112. Further, in one implementation, the locking device 100 includes a supporting strap 118 provided along the length of the cable 102, such that the user may be able to conveniently lift the object 10, using the locking device 100 as the handle, by placing his/her hand around the supporting strap 118. It may be appreciated that the use of the supporting strap 118 ensures that the cable 102 does not put much pressure on the hand of the user while lifting the object 10 while using the locking device 100 as the handle.

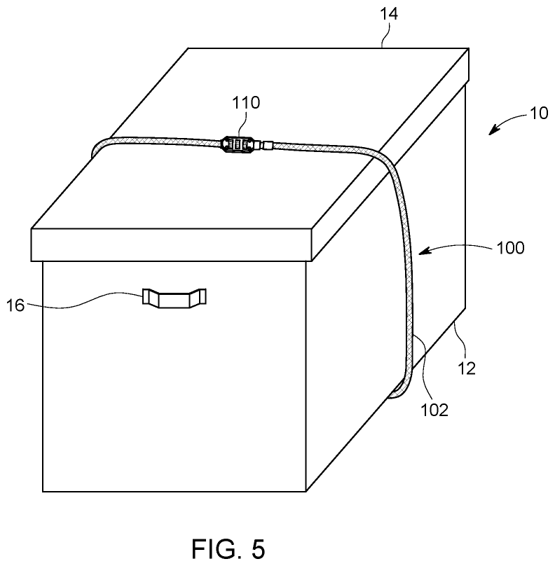

FIG. 5 illustrates an implementation of the locking device 100 being used for securing the lid 14 on the box 12 in the object 10, so as to lock the object 10 itself. Herein, the cable 102 is directed to encircle the box 12 of the object 10 along with the lid 14 along one of the axis, preferably shorter axis, of the object 10, and thereafter the male connector 108 is locked in the female connector 112. It will be appreciated that the length of the cable 102 may be customized as per the size and/or shape of the object 10, especially for implementations as described in FIGS. 4-5; and in such case, the locking device 100 with customized length of the cable 102 can be packaged as part of the purchase of the object 10. Further, it may be contemplated by a person skilled in the art that the locking device 100 can be implemented for various similar applications for securing objects of different shapes and sizes, as described above.

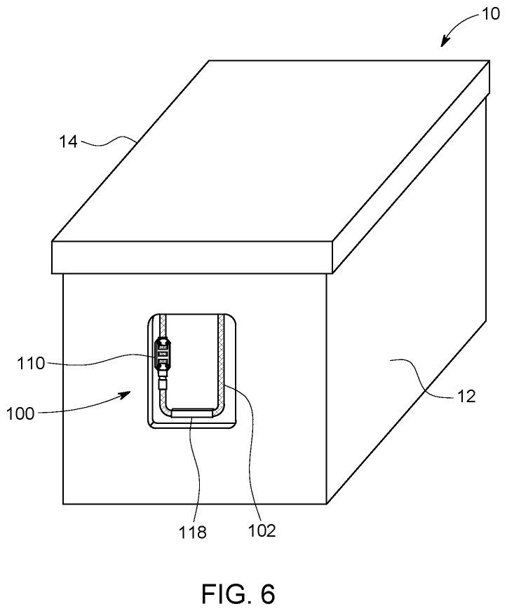

FIG. 6 illustrates an implementation of the locking device 100 being used as a side-handle for the object 10. As illustrated, in such implementation, the cable 102 may extend through some fixed means (not shown) arranged on the side of the box 12 of the object 10. Such fixed means may be in the form of eyelets or handle arranged on the side of the box 12 of the object 10. Herein, such fixed means may be hidden behind groove (as shown) formed in the side of the box 12 of the object 10. Thereafter, the male connector 108 is locked in the female connector 112, to couple the locking device 100 to the object 10. Further, as illustrated, the locking device 100 includes a supporting strap 118 provided along the length of the cable 102, such that the user may be able to conveniently lift the object 10, using the locking device 100 as the handle, by placing his/her hand around the supporting strap 118. It may be appreciated that the use of the supporting strap 118 ensures that the cable 102 does not put much pressure on the hand of the user while lifting the object 10 while using the locking device 100 for pulling the object 10. It may be appreciated that the disclosed arrangement of FIG. 6 can also be implemented for securing the object 10 to a fixture, such as the fixture 20.

The locking device 100 of the present disclosure is portable and light-weight, and can be easily carried by the user to a vacation spot or the like, for locking desired objects. The locking device 100 balances the need for security with the need for convenience, as compared to prior-art devices which are lacking in convenience in regular use. By simple dialing operation of the locking member 110, the locking device 100 can be instantly served for locking or unlocking a portable equipment without further preparing a lock and a key for unlocking the lock. The cable 102 being incased with flexible metal wire 104 ensures that the cable 102 cannot be cut easily and thus provided further safeguard against possible theft. The present locking device 100, with inline locking member 110, therefore provides a simple and convenient locking means for securing as well as handling the personal equipment and objects.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A locking device, comprising:
a cable having a first end and a second end, wherein the cable includes a flexible metal wire extending throughout a length thereof and an outer protective cover enclosing the flexible metal wire therein;
a male connector arranged at the first end of the cable; and
a locking member arranged at the second end of the cable, wherein the locking member includes a female connector with a radial through hole so as to mateably receive at least a portion of the male connector therein to engage therewith, and wherein the locking member is configured to lock the male connector in the female connector when engaged therewith so as to form a closed loop of the cable.

2. The locking device of claim 1, wherein the locking member is a combination lock.

3. The locking device of claim 2, wherein the locking member includes:
a housing; and
a plurality of dials rotatably mounted in the housing, wherein the male connector is locked in the female connector by operating one or more of the plurality of dials to a locking combination.

4. The locking device of claim 1 further comprising a supporting strap arranged along the length of the cable therein.

5. The locking device of claim 1, whereby upon direction of the cable such that the male connector passes through a fastener of an object and encircle a fixture, the male connector is locked in the female connector for locking the object to the fixture.

6. The locking device of claim 1, wherein the length of the cable ranges from 50 centimeters to 500 centimeters.
